(19) United States
(12) Patent Application Publication
(10) Pub. No.: US 2025/0263062 A1
(43) Pub. Date: Aug. 21, 2025

(54) Electric Vehicle Range Extender with Integrated Thermal-Management System

(71) Applicant: Vincent Loccisano, Wellesley, MA (US)

(72) Inventor: Vincent Loccisano, Wellesley, MA (US)

(21) Appl. No.: 19/198,580

(22) Filed: May 5, 2025

(51) Int. Cl. B60W 20/13; B60H 1/00; B60W 10/06; B60W 10/30

(52) U.S. Cl. CPC B60W 20/13; B60H 1/004; B60W 10/06; B60W 10/30; B60W 2555/20; B60W 2710/06; B60W 2710/244; B60W 2710/246

(57) ABSTRACT

The present invention is an on-board electric-vehicle-range-extender system made up of an internal combustion engine (ICE) that drives an electrical generator that is electrically coupled with the vehicle's EV battery pack. A thermal-energy management module is made up of at least one fluid path and at least one heat exchanger. In one example the heat exchanger recovers waste heat from the ICE cooling process and directs the heat to a heat exchanger in the EV battery pack for thermoregulation of the EV battery pack, or to an inhabited space in the vehicle, or to a heat exchanger exposed to the ambient environment. Thermoregulation may occur in advance of a scheduled charge particularly in advance of high-speed DC charging, or to keep the battery pack at an optimum operating temperature during use. Heating batteries to an optimal temperature ahead of a scheduled heavy use may reduce battery degradation.

### TECHNICAL FIELD

The present disclosure relates generally to electric vehicles (EVs) and more specifically to a system and method for improving cold-weather performance in EVs, with an on-board range extender coupled with a battery-management system.

### BACKGROUND OF THE INVENTION

Thermoregulation is an important component of battery management in electric vehicles (EVs). Even when ambient temperature is high, achieving an ideal operating condition for high-speed charging of an EV battery pack may still require heating the battery pack. The current state of the art employs a variety of inefficient methods to heat a battery pack to an ideal temperature. In one example a battery management system employs EV battery power to power a heating system to heat the battery pack to an ideal temperature in advance of high-speed DC Charging. In another example the EV control system will run electric motors inefficiently to generate heat that is then transferred through a heat exchanger to heat the batteries.

Electric vehicle (EV) batteries suffer from reduced performance and efficiency in cold-weather conditions. Most EV batteries are made of lithium-ion cells, the physical and chemical properties of which are negatively affected by low temperatures. Cold weather impairs the batteries' ability to deliver power, leading to reduced driving ranges and increased energy consumption. Although some EVs employ preconditioning and maintenance protocols to keep batteries at optimal operating temperatures, these protocols require considerable energy, further reducing the vehicle's range.

EVs have sophisticated battery-management systems (BMS) that monitor battery temperature and automatically activate heating or cooling systems as needed to maintain that temperature. Many EVs have a preconditioning feature that uses electric heating elements in a battery pack to warm the battery pack before the vehicle is driven. This feature is most effective when the vehicle is plugged in and charging, as it draws power from the grid rather than from the battery pack. When not plugged in, this feature may pull electrical energy from the batteries, which expends energy and reduces EV range.

Some EVs employ heat pumps to extract heat from the surrounding air to control the battery's temperature. Other EVs generate heat by running the EV electric motor in a non-optimized way, leading to energy inefficiency and wear on the motor(s).

In extreme cold conditions, the BMS may limit or disable regenerative braking. Regenerative braking uses the vehicle's electric motor as a generator to capture the energy required to slow the vehicle and convert mechanical energy into electrical energy, which is used to charge the batteries.

Cold batteries cannot accept a charge as quickly as warm batteries, and rapidly charging a cold battery, as may happen with aggressive regenerative braking, could damage it. Cold batteries charge slower than warm batteries, and charging lithium-ion batteries in extremely cold temperatures may lead to lithium plating, which could damage a battery.

EVs often prioritize heating the battery compartment over heating an inhabited area such as the living space in an RV or a vehicle cabin, also referred to as a climate-controlled area. For example, when batteries are cold, an EV may be programmed to heat seats and a steering wheel rather than warm the entire climate-controlled area.

An optimal operating temperature for an EV battery pack is often considered to be between 15° C. and 35° C. for optimal performance and longevity. Performance refers to power output and charging speed while the term longevity refers to minimizing degradation to extend battery live. Temperatures closer to the middle of this range, between 20° C. and 25° C. are often cited as optimal for least degradation of the battery pack, for battery longevity. Heavy loading such as towing, or driving long distances with a fully loaded vehicle may best be performed with an EV battery pack at or near it's optimal temperature. High-speed DC charging performed at or near the optimal temperature ensures best outcomes for fast charging and battery longevity.

These methods introduce inefficiencies into the EV system and impose a considerable energy burden on an EV battery, exacerbating range-reduction issues already caused by cold weather. There remains a need for a battery-management system that maintains optimum battery temperatures without compromising battery-energy reserves in cold weather conditions or in advance of high-speed DC charging.

### SUMMARY OF THE INVENTION

The present invention is an on-board electric-vehicle-range-extender system made up of an internal combustion engine (ICE) that drives an electrical generator that is electrically coupled with the vehicle's EV battery pack. A thermal-energy management module is made up of at least one fluid path and at least one heat exchanger. In one example the heat exchanger recovers waste heat from the ICE cooling process and directs the heat to a heat exchanger in the EV battery pack for thermoregulation of the EV battery pack, or to an inhabited space in the vehicle, or to a heat exchanger exposed to the ambient environment. Thermoregulation may occur in advance of a scheduled charge or an anticipated arrival at a charging station, particularly in advance of high-speed DC charging. Thermoregulation may alternatively occur to keep the battery pack at an optimum operating temperature during use, regardless of the ambient temperature. Heating batteries to an optimal temperature range, ahead of a scheduled heavy use may reduce battery degradation and increase battery longevity.

Excess heat from the ICE may be directed to a traditional air-to-fluid heat exchanger (commonly referred to as a radiator) or may be directed to a fluid-to-fluid heat exchanger.

To warm a battery pack to an optimal temperature, a thermal-energy management module may direct hot coolant from the running ICE, through a fluid path to a fluid-to-fluid heat exchanger in the battery pack. By recovering waste heat from the ICE range extender's cooling process, the thermal-energy management module ensures that the battery pack is preconditioned and maintained at an ideal operating temperature for driving and charging. When excess heat from the ICE is not required to warm the batteries, it may be routed through a fluid path to an alternative heat exchanger such as a radiator or climate-control heating system, bypassing the fluid-to-fluid heat exchanger that runs through the battery pack.

In an example application, the range extender may be activated to run the ICE prior to initiating a high-speed DC charge. This procedure preconditions the batteries to the proper temperature for a fast-charge process while charging the batteries. A user-scheduled preheating feature initiates the range extender to charge the batteries and warm the battery pack at a time set by the user prior to travel, in advance of an estimated time of arrival at a high-speed DC charger. An automated preheating feature engages the ICE based on ambient conditions. A preset threshold temperature engages the ICE and waste heat is transferred to the battery pack to raise the temperature above the threshold temperature to an optimal temperature. If the battery pack is not fully charged the ICE may charge the batteries. If the battery pack is fully charged, the ICE may run without engaging the electric generator and therefore will not charge the battery pack.

A battery-management system (BMS) controls the electricity and heat from the range extender to the battery pack to maintain the batteries at an optimal temperature and charge.

### BRIEF DESCRIPTION OF DRAWINGS

FIG. 1 is an illustration of an embodiment 100 depicting an internal-combustion-engine-driven electrical generator in an electric vehicle.

FIG. 2 is a diagram of the embodiment of FIG. 1.

FIG. 3 is a diagram of a method of using the embodiment of FIG. 1 and FIG. 2.

FIG. 4 is a diagram of a method of using the embodiment of FIG. 1 and FIG. 2.

### DETAILED DESCRIPTION

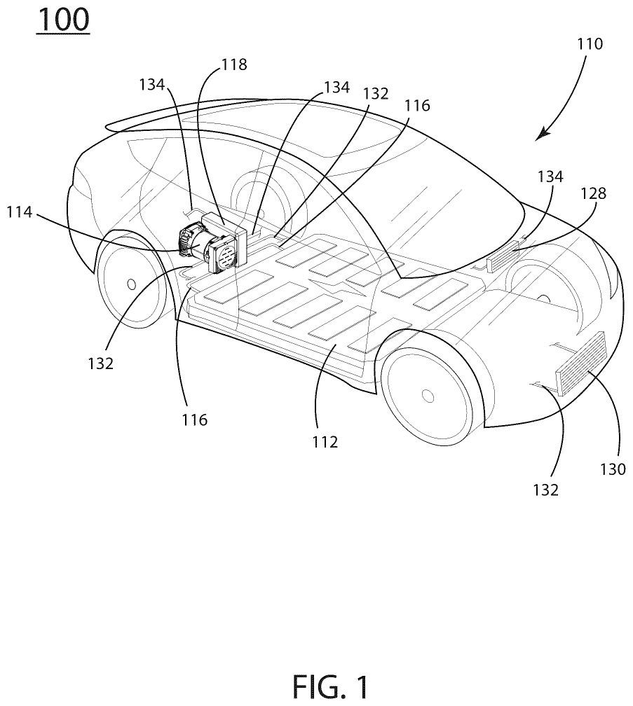

FIG. 1 shows an example embodiment 100. An electric vehicle 110 has a battery pack 112 and an ICE generator 114 that is further connected to a manifold 118. The manifold 118 has a system of valves that are configured to direct hot fluid through a first fluid path 116 through a fluid-to-fluid heat exchanger to the battery pack 112, through second fluid path 132 to a fluid-to-air heat exchanger 130 and through a third fluid path 134 to a fluid-to-air heat exchanger 128 providing climate-control.

In one example, the ICE generator 114 is engaged to generate electricity to charge the batteries 112. As the ICE generator is charging the batteries, heat is transferred from the heat exchanger 118 through fluid path 116 to heat the battery pack 112. This may occur in cold weather while the vehicle is parked, prior to a scheduled trip or prior to high-speed DC charging.

In another example, the battery pack 112 is fully charged yet the batteries are colder than their optimal temperature. The ICE may engage without engaging the generator, heat is directed to the batteries through fluid path 116 to warm them to their optimal temperature without charging the batteries.

In yet another example, the batteries are at or above their optimal temperature and in need of a charge from the ICE generator. Heat is then conducted through fluid path 132 to a fluid-to-air heat exchanger 130, or through fluid path 134 to a fluid-to-air heat exchanger 128 that heats the vehicle's climate-controlled area.

Fluid paths are shown in cut lines for clarity. One skilled in the art is familiar with fluid to air heat exchangers that loop conduit through a heat exchanger.

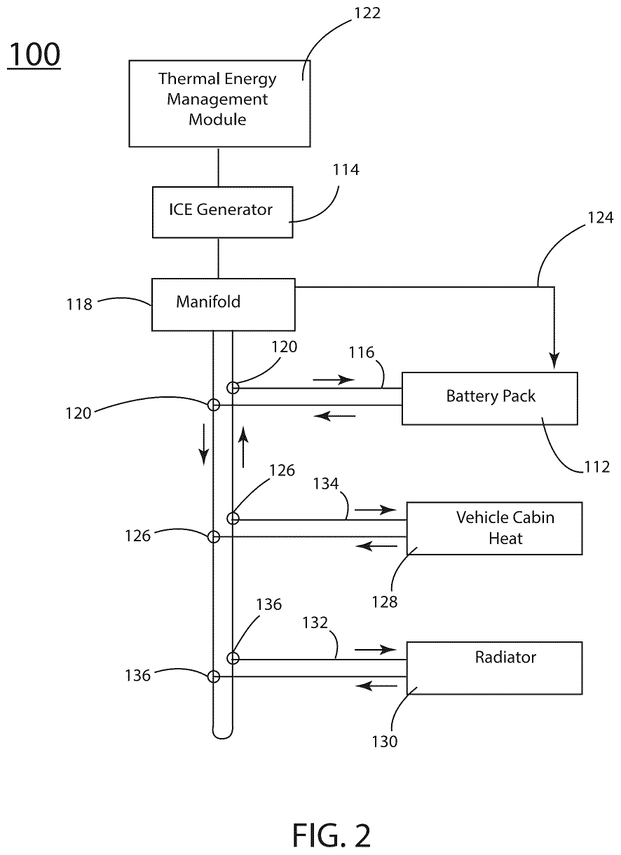

FIG. 2 describes the components and function of the apparatus of FIG. 1. A thermal-energy management module controls the ICE and generator heat and electrical energy. The thermal-energy management module is a computer application stored in the electric vehicle controller area network computer, that monitors battery-energy levels and battery temperature, and controls the ICE generator 114 and valves in the manifold 118. Electrical energy from the ICE generator 114 is delivered to the battery pack to charge the batteries 124. A first set of valves 120 may be engaged to divert hot fluid from the ICE to a fluid path 116 and to a fluid-to-fluid heat exchanger in the battery pack 112. A second set of valves 126 may be engaged to direct hot fluid from the ICE to a fluid path 134 and to a fluid-to-air heat exchanger 128 in the vehicle's climate controlled area. A third set of valves 136 may be engaged to direct hot fluid from the ICE to a fluid path 132 and to a fluid-to-air heat exchanger exposed to the ambient environment also referred to a radiator 130.

In one example the thermal-energy management module controls valves 120 that control the flow of liquid from the ICE generator 114 to a fluid-to-fluid heat exchanger loop that heats the battery pack 112.

In another example, the thermal-management system diverts excess waste heat from the ICE generator 114 through valves 126 to a fluid-to-air heat exchanger 128 that heats the vehicle's climate controlled area.

In another example, the thermal-management system diverts excess waste heat from the ICE generator 114 through valves 136 to a fluid-to-air heat exchanger, such as a radiator 130 that dispels waste heat outside of the vehicle.

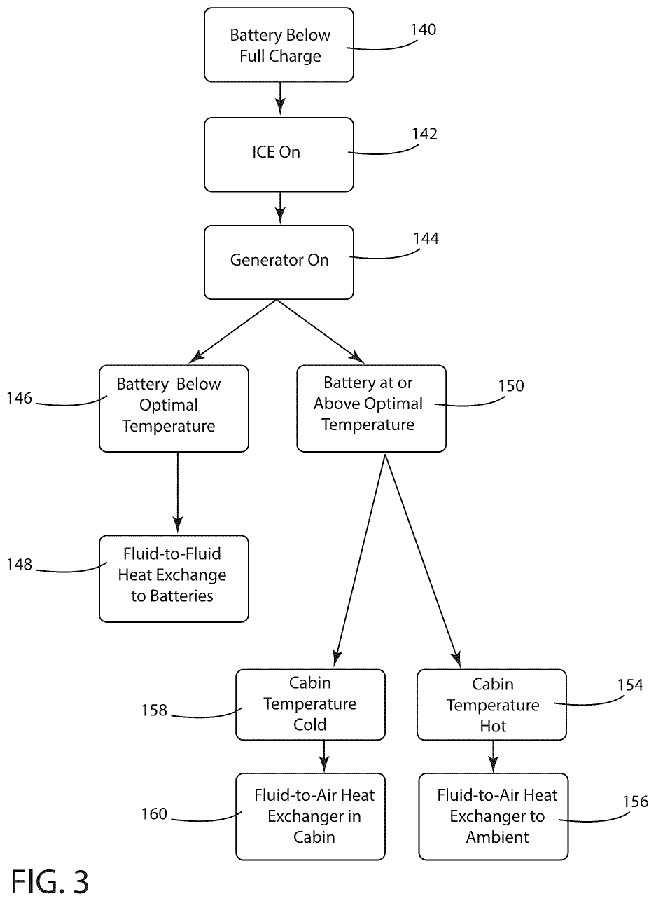

FIG. 3 is a diagram of a method of operating the electric-vehicle-range-extender system when a battery pack is below full charge. A vehicle on-board computer storing an application controls the ICE and generator while monitoring battery temperature and heat exchangers. The method begins by designating the battery pack is below full charge 140 wherein the application engages the ICE 142 and engages the generator 144. If the battery is below an optimal temperature 146, the application creates a fluid path to direct hot fluid from the ICE to a fluid-to-fluid heat exchanger in the battery pack 148. One skilled in the art understands that a fluid path may be created, in some embodiments, by configuring valves to direct the flow of fluid. If the battery is at or above an optimal temperature 150, the application queries the climate-control temperature against a temperature set by a user. If the climate-control temperature is below the temperature set by the user 158 the application creates a fluid path to direct the hot fluid from the ICE to a fluid-to-air heat exchanger in the climate-controlled region 160. If the climate temperature is above the temperature set by the user 154 the application creates a fluid path to direct the hot fluid from the ICE to a fluid-to-air heat exchanger that dispels the heat to the ambient air 156.

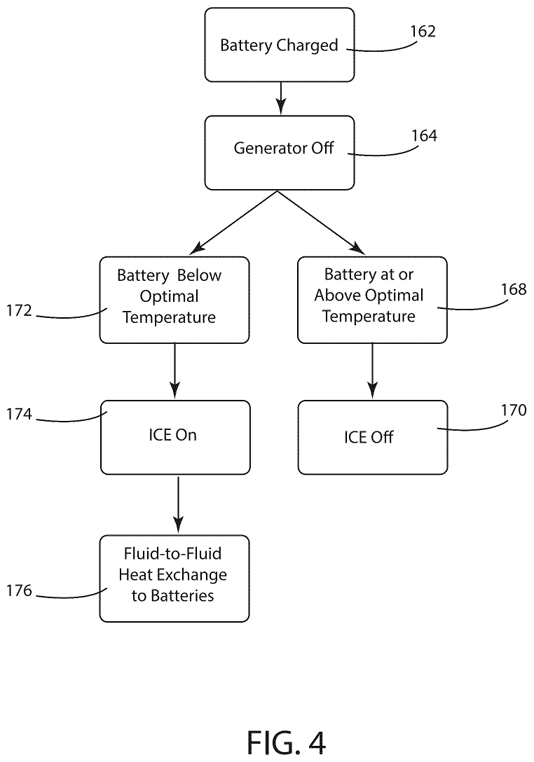

FIG. 4 is a diagram of a method of operating the electric-vehicle-range-extender system when a battery pack is fully charged. A vehicle on-board computer storing an application controls the ICE and generator while monitoring battery temperature and heat exchangers. The method begins by designating the battery pack is fully charged 162 wherein the application disengages the generator 164. If the battery is below an optimal temperature 172, the application engages the ICE 174 and creates a fluid path to direct hot fluid from the ICE to a fluid-to-fluid heat exchanger in the battery pack 176. If the battery is at or above an optimal temperature 150, the application disengages the ICE 170.

1. A thermal-management system for an electric vehicle comprising:
an internal combustion engine coupled with an electrical generator further electrically coupled with a battery pack in the electric vehicle; and
at least one conduit configured to transfer heat from the internal combustion engine to at least one heat exchanger; and
a processor storing an application configured to control the internal combustion engine and electrical generator, the flow of electricity to the battery pack and the transfer of heat to the at least one heat exchanger.

2. The thermal-management system of claim 1 wherein:
the battery pack is maintained at an optimal temperature for high-speed DC charging.

3. The thermal-management system of claim 1 wherein:
the battery pack is maintained at an optimal temperature for charging in cold weather.

4. The thermal-management system of claim 1 wherein:
the battery pack is brought to an optimal temperature in advance of a scheduled use.

5. The thermal-management system for an electric vehicle of claim 1 wherein:
the at least one heat-exchanger is a fluid-to-air heat exchanger.

6. The thermal-management system for an electric vehicle of claim 5 wherein the fluid-to-air heat exchanger is a radiator; wherein
heat is dispelled to the ambient environment.

7. The thermal-management system for an electric vehicle of claim 5 wherein the fluid-to-air heat exchanger is a climate-control heater; wherein
heat is directed to a vehicle inhabited space.

8. The thermal-management system for an electric vehicle of claim 1 wherein:
the application is configured to control charging and heating of batteries according to a preset schedule.

9. The thermal-management system for an electric vehicle of claim 1 wherein:
the application is configured to control charging and heating of batteries according to an anticipated arrival at a charging station.

10. The thermal-management system for an electric vehicle of claim 1 wherein:
the apparatus is integrated into a plug-in hybrid electric vehicle.

11. A thermal-management system for an electric vehicle comprising:
an internal combustion engine coupled with an electrical generator further electrically coupled with a battery pack in the electric vehicle; and
a manifold configured to circulate fluid through the internal combustion engine to draw heat from the internal combustion engine; and
said manifold having at least a first fluid pathway to a first heat exchanger in the battery pack; and
said manifold having a second fluid pathway to a second heat exchanger exposed to the ambient environment; and
a processor storing an application configured to control the internal combustion engine and electrical generator; wherein
the first fluid pathway and second fluid pathway may be individually controlled to allocate a portion of heat from the internal combustion engine to said first heat exchanger and said second heat exchanger; wherein
the battery pack is charged and maintained at an optimal temperature for charging and discharging.

12. The system of claim 11 further comprising:
said manifold having at least a third fluid pathway to a third heat exchanger in an inhabited area in the vehicle.

13. The system of claim 11 wherein:
said first heat exchanger is a fluid-to-fluid heat exchanger.

14. The system of claim 11 wherein:
said second heat exchanger is a fluid-to-air heat exchanger.

15. The system of claim 12 wherein:
said third heat exchanger is a fluid-to-air heat exchanger.

16. A method for operating the thermal-management system of claim 11, the method comprising:
determining that the battery pack is not fully charged; and
engaging the internal combustion engine; and
engaging the generator; and
determining that the battery pack is below an optimal temperature; and
engaging said first fluid pathway; wherein
heat drawn from the internal combustion engine is directed to the heat exchanger in the battery pack to heat the battery pack.
